(19) United States
(12) Patent Application Publication
(10) Pub. No.: US 2016/0131574 A1
(43) Pub. Date: May 12, 2016

(54) METHOD FOR SCREENING VITAMIN D INSUFFICIENCY USING SKIN COLOURIMETRY

(71) Applicant: The Chinese University of Hong Kong, Hong Kong (CN)

(72) Inventors: Tsz Ping Lam, Hong Kong (CN); Jack Chun Yiu Cheng, Hong Kong (CN); Kwong Man Lee, Hong Kong (CN)

(21) Appl. No.: 14/933,485

(22) Filed: Nov. 5, 2015

Related U.S. Application Data
(60) Provisional application No. 62/076,050, filed on Nov. 6, 2014.

(51) Int. Cl. G01N 21/25

(52) U.S. Cl. CPC G01N 21/251; G01N 2201/12

(57) ABSTRACT

The present application provides a method for establishing a protocol for screening vitamin D (vit-D) insufficiency in a population of interest, a method for screening Vit-D insufficiency using the protocol, and a device for screening Vit-D insufficiency developed based on the protocol.

### CROSS REFERENCE TO RELATED APPLICATIONS

The present application claims benefit of priority to U.S. Patent Application No. 62/076,050 filed on Nov. 6, 2014, the disclosure of which is incorporated by reference herein in its entirety.

### TECHNICAL FIELD

The present application generally relates to a method and device for screening vitamin D (Vit-D) insufficiency. In particular, the present application relates to a method and device for screening vitamin D insufficiency based on skin colourimetry.

### BACKGROUND

Vit-D is important for skeletal growth and bone mineralization during pubertal growth. The best indicator for Vit-D status is serum 25(OH)Vit-D level with Vit-D insufficiency being diagnosed when serum 25(OH)Vit-D≦50 nmol/L(1). Vit-D insufficiency has been reported to be highly prevalent across all age groups in different countries and geographical regions (2). In spite of this, the potentially treatable condition remains under-recognized resulting in perpetuation of a global epidemic in Vit-D insufficiency (3) and the adolescent group is no exception. Apart from inadequate awareness for this health problem and the absence of symptoms in its early stage, the lack of screening tests can be the culprit. Serum 25(OH)Vit-D assay requires blood taking which is costly, not readily available and is not suitable as a screening tool for the young population. Neither are the sunlight exposure questionnaire (4-6) nor the personal UV dosimeter (7). Predictive models using patient's demographic and lifestyle characteristics have been reported but were confined to adults and the elderly (4, 8-11).

There remains in the art a long-awaited quest for an effective screening tool for Vit-D insufficiency.

### SUMMARY

The present application provides a non-invasive method and device for screening of Vit-D insufficiency.

In a first aspect disclosed herein, there provided is method for establishing a process for screening vitamin D (Vit-D) insufficiency in a population of interest, comprising

determining a Vit-D status of a cohort of subjects of the population by measuring serum 25(OH)Vit-D level, wherein serum 25(OH)Vit-D level≦50 nmol/L indicates Vit-D insufficiency, and serum 25(OH)Vit-D level>50 nmol/L indicates Vit-D sufficiency, and wherein Vit-D insufficiency status is designated a value of “1” and Vit-D sufficiency status is designated a value of “0”;

obtaining a set of factors including constitutive skin melanin pigmentation measurement (Vf) and facultative skin melanin pigmentation measurement (Vh) in an individual subject, and one selected from the group consisting of: an age, a season, a gender, a body weight (BW), a standing height (SH), a physical activity level (PAL), a daily dietary Vit-D intake (Dvd), a daily dietary calcium intake (Dca), or any combination thereof in the individual subject, or transformed formats of the factors, wherein Vf is measured using skin colourimetry on an instep area, an inner aspect or a sole of a foot, or a heel of the individual subject, Vh is measured using skin colourimetry on a dorsum of a hand, fingers, a thumb or a wrist of the individual subject, the age, the BW, the SH, the PAL, the Dvd or the Dca is determined from the individual subject, the seasons are differentially designated pre-set values, and the genders are differentially designated pre-set values, and

carrying out a logistic regression analysis by using a Vit-D status as a dependent variable, and the factors or the transformed formats of the factors as independent variables, thereby obtaining a function as shown below with regression coefficients for each of the independent variables:

$${log}_{e} ( \frac{Pred}{1 - Pred} ) = α + {\sum }_{1}^{k} {β}_{i} {x}_{i} ,$$

wherein α is a constant term,

βᵢ is a regression coefficient for an independent variable xᵢ,

xᵢ represents the individual independent variables,

k represents a total number of the independent variables,

Pred is a predicted probability used for determining a screening result of either Vit-D insufficiency or Vit-D sufficiency according to a pre-set cut-off threshold of Pred.

In some embodiments, Vf and/or Vh is measured using Individual Typology Angle (ITA) based on a skin colourimetry system, e.g. L*a*b* colour system.

In some embodiments, in season factors, summer is designated value “1” and winter is designated value “2”.

In some embodiments, in gender factors, male is designated value “1” and female is designated value “2”.

In some embodiments, the population of interest is an Asian population.

In some embodiments, the population of interest is a Chinese population.

In some embodiments, the population of interest is adolescent population in

Hong Kong, and the obtained function is:

Logₑ(Pred/(1−Pred))=0.072(Vh)−0.095(Vf)−0.09(season)−0.297(gender)−0.005(BW/SH²)−0.29(age)+8.055.

In some embodiments, the population of interest is female adolescent population in Hong Kong with daily dietary Vit-D intake≦400 IU/day, and the obtained function is:

Logₑ(Pred/(1−Pred))=0.131(Vh)−0.162(Vf)−0.293(season)−0.104(BW/SH²)−0.358(age)+12.997.

In some embodiments, the population of interest is adolescent population in Hong Kong, and the obtained function is:

Logₑ(Pred/(1−Pred))=0.057(Vh)−0.087(Vf)−0.22(season)−0.015(gender)+0.007(BW)−0.034(SH)−0.203(age)−0.6(PAL)+13.388.

In some embodiments, the pre-set cut-off threshold of Pred is about 0.61.

In a second aspect disclosed herein, there provided is a method for screening vitamin D (Vit-D) insufficiency in a subject, comprising

providing a function for screening vitamin D (Vit-D) insufficiency in a population that the subject is from according to the method as described in the first aspect,

obtaining a set of factors in the subject as defined in the function,

introducing the set of factors into the function thereby obtaining a Pred, and

comparing the calculated Pred with a pre-set cut-off threshold of Pred, wherein the calculated Pred≧the pre-set cut-off threshold of Pred indicates Vit-D insufficiency, and the calculated Pred<the pre-set cut-off threshold of Pred indicates Vit-D sufficiency.

In some embodiments, the providing a function for screening vitamin D (Vit-D) insufficiency includes establishing a function for screening vitamin D (Vit-D) insufficiency in a population that the subject is from according to the method as described in the first aspect.

In a third aspect disclosed herein, there provided is a device for screening vitamin D (Vit-D) insufficiency in a subject, comprising

a measuring module configured to measure and record constitutive skin melanin pigmentation measurement (Vf) and facultative skin melanin pigmentation measurement (Vh) in the subject based on skin colourimetry, wherein Vf is measured on the instep area, the inner aspect or the sole of the foot, or the heel of the subject, and Vh is measured on the dorsum of the hand, the fingers, the thumb or the wrist of the subject,

an inputting module configured to record one or more or all of age, season, gender, body weight (BW), standing height (SH), physical activity level (PAL), daily dietary Vit-D intake (Dvd) and daily dietary calcium intake (Dca) in the subject, or transformed formats of the factors, wherein, age, BW, SH, PAL, Dvd or Dca is determined from the subject, seasons are differentially designated pre-set values, and male and female are differentially designated pre-set values, and

an processing module configured to run a function for screening vitamin D (Vit-D) insufficiency in a population that the subject is from according to the method described in the first aspect and calculate a Pred.

In some embodiments, the device further comprises a comparing module configured to compare the calculated Pred with a pre-set cut-off threshold of Pred, wherein the calculated Pred≧the pre-set cut-off threshold of Pred indicates Vit-D insufficiency, and the calculated Pred<the pre-set cut-off threshold of Pred indicates Vit-D sufficiency.

In some embodiments, the measuring module works based on Individual Typology Angle (ITA) measure, e.g. L*a*b* colour system.

In some embodiments, all the modules are incorporated into a skin colourimetry system, e.g. a skin colourimeter.

In a fourth aspect disclosed herein, there provided is a computer product comprising a computer readable medium storing a plurality of instructions for carrying out the method of the first and/or the second aspect.

### BRIEF DESCRIPTIONS OF DRAWINGS

FIG. 1 is an exemplary skin colourimeter based on L*a*b* colour system used in some embodiments of the present application;

FIG. 2 illustrates an ROC curve for all subjects; and

FIG. 3 illustrates an ROC curve for females with daily dietary Vit-D intake<400 IU/day.

### DETAILED DESCRIPTIONS

The present application is at least partially based on the conception of potential use of skin colourimetry in screening vitamin D (Vit-D) insufficiency.

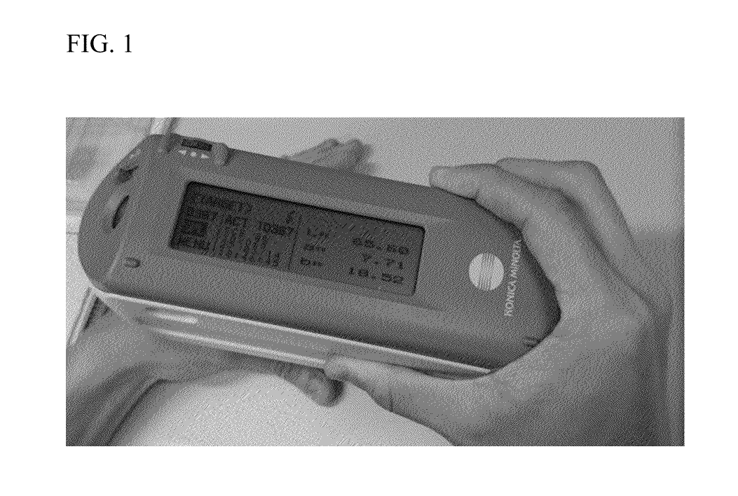

Skin colourimetry can be used to measure skin melanin pigmentation. Melanin absorbs UV radiation and thus prevents UV photons from converting 7-dehydrocholesterol to previtamin D3 (the precursor for Vit-D)(3). This natural amount of melanin present in the unexposed skin is represented by the constitutive skin colour. On the other hand, the colour of skin exposed to sunlight gets darker (tanning) with greater UV exposure resulting in higher Vit-D level. This facultative skin colour is the surrogate measurement of sunlight exposure. The combined interpretation of unexposed skin colour (the constitutive skin colour) and exposed skin colour (the facultative skin colour) can be used respectively to assess dermal capability in synthesizing Vit-D and the degree of sunlight exposure(12). With recent advancement in reflectance colourimetry, non-invasive measurement of the natural constitutive skin colour and the facultative skin colour can be swiftly done with a hand-held optical device (skin colourimeter, see FIG. 1 for an example). Since local dietary sources of Vit-D are scanty (3, 13), the main source of Vit-D is from sunlight-dependent dermal synthesis the extent of which and hence the Vit-D status of subjects is supposed to be effectively assessed by skin colourimetry.

Although various usefulness of skin colourimetry has been reported in the art, no study has been conducted to evaluate its role in screening for Vit-D insufficiency. Thus, one object of the present application is to evaluate whether skin colourimetry can be used to screen for Vit-D insufficiency, and develop a screening tool based on skin colourimetry.

The inventors of the present application also contemplate a series of confounding factors which may impact the Vit-D level in a subject, and thus incorporate the factors into the method or device for screening for Vit-D insufficiency in the present application.

In a first aspect disclosed herein, there provided is method for establishing a process for screening vitamin D (Vit-D) insufficiency in a population of interest, comprising determining a Vit-D status of a cohort of subjects of the population by measuring serum 25(OH)Vit-D level, wherein serum 25(OH)Vit-D level≦50 nmol/L indicates Vit-D insufficiency, and serum 25(OH)Vit-D level>50 nmol/L indicates Vit-D sufficiency, and wherein Vit-D insufficiency status is designated a value of “1” and Vit-D sufficiency status is designated a value of “0”;

obtaining a set of factors including constitutive skin melanin pigmentation measurement (Vf) and facultative skin melanin pigmentation measurement (Vh) in an individual subject, and one selected from the group consisting of: an age, a season, a gender, a body weight (BW), a standing height (SH), a physical activity level (PAL), a daily dietary Vit-D intake (Dvd), a daily dietary calcium intake (Dca), or any combination thereof in the individual subject, or transformed formats of the factors, wherein Vf is measured using skin colourimetry on an instep area, an inner aspect or a sole of a foot, or a heel of the individual subject, Vh is measured using skin colourimetry on a dorsum of a hand, fingers, a thumb or a wrist of the individual subject, the age, the BW, the SH, the PAL, the Dvd or the Dca is determined from the individual subject, the seasons are differentially designated pre-set values, and the genders are differentially designated pre-set values, and

carrying out a logistic regression analysis by using a Vit-D status as a dependent variable, and the factors or the transformed formats of the factors as independent variables, thereby obtaining a function as shown below with regression coefficients for each of the independent variables:

$${log}_{e} ( \frac{Pred}{1 - Pred} ) = α + {\sum }_{1}^{k} {β}_{i} {x}_{i} ,$$

wherein α is a constant term,

βᵢ is a regression coefficient for an independent variable xᵢ,

xᵢ represents the individual independent variables,

k represents a total number of the independent variables,

Pred is a predicted probability used for determining a screening result of either Vit-D insufficiency or Vit-D sufficiency according to a pre-set cut-off threshold of Pred.

The inventors of the present application contemplate the unique feature of the method (i.e. skin colourimetry based technology) and the differences of various populations in nature, e.g. place of residence, climate, skin colour, general physical constitution, etc, and develop a method that can be applied to any population of interest on which the screening is to be conducted.

In general, the method is based on analysis of skin colourimetry measurements and other relevant factors in a group of subjects with definite diagnosis of Vit-D insufficiency or Vit-D sufficiency, and generation of a function which can be extended and applied to a population that the group of subjects are from and represent.

As used herein, the term “a population of interest” means any population with common nature(s). For example, “a population of interest” can be a population that lives in the same city, region, country or continent. Alternatively, “a population of interest” can be a population that is within a certain age range. Also, “a population of interest” can be a population that has same basic skin colour. As understood by a person skilled in the art, the more common features the population of interest shares, the more efficiency (e.g. sensitivity, specificity, accuracy etc.) the function will have. An appropriate selection of “a population of interest” would be within the capability of a person skilled in the field of epidemiology. In some embodiments, the population of interest is an Asian population. In some embodiments, the population of interest is a Chinese population.

In some embodiments, in determining a Vit-D status of the method disclosed herein, a cohort of subjects of the population is statistically selected as being representative of the population, to create the function. Cohort study is commonly used in the field of epidemiology, and the qualification of a cohort would be appreciated by a person skilled in the art. In some embodiments, the subjects do not suffer from medical conditions that affect bone metabolism.

In some embodiments, determining a Vit-D status includes determining Vit-D insufficiency or Vit-D sufficiency in each subject in the cohort. The determination is based on serum 25(OH)Vit-D level assay. Serum 25(OH)Vit-D level is the best indicator of Vit-D status (19). In some embodiments, the assay can be performed using the gold standard of liquid chromatography tandem mass spectrometry (LCTMS) with details of method described previously (20, 21), as demonstrated in the Examples.

Obtaining a set of factors includes generating a series of factors associated with Vit-D status in a subject, including skin colourimetry measurements (constitutive skin melanin pigmentation measurement (Vf) and facultative skin melanin pigmentation measurement (Vh)) and other confounding factors, such as age, season, gender, body weight (BW), standing height (SH), physical activity level (PAL), daily dietary Vit-D intake (Dvd), daily dietary calcium intake (Dca) or any combination thereof. It shall be understood that transformed formats of these factors can also be used.

Constitutive skin melanin pigmentation measurement (Vf) can be measured using skin colourimetry on the instep area, the inner aspect or the sole of the foot, or the heel of individual subject. In some embodiments, Vf is measured on the non-dominant foot. In a particular embodiment, Vf is measured on the instep area of the non-dominant foot. Facultative skin melanin pigmentation measurement (Vh) can be measured using skin colourimetry on the dorsum of the hand, the fingers, the thumb or the wrist of individual subject. In some embodiments, Vh is measured on the non-dominant hand. In a particular embodiment, Vf is measured on the dorsum of the non-dominant hand. In some embodiments where an L*a*b* colour measurement system is used, Vf and Vh are in degrees.

In some embodiments, skin colourimetry is Individual Typology Angle (ITA) based on skin colourimetry, e.g. L*a*b* colour system. ITA is used to measure skin melanin pigmentation, and parameters for the sites to be measured. Skin colourimeters have been developed in the art, one example of which is CM-2300D Skin Colourimeter manufactured by Konica-Minolta which is exemplarily used in the Examples of the present application, and can generate the data of L and b from which the ITA is calculated. It shall be understood that skin colourimetry based on other mechanisms can also be used as long as skin colourimetry measurements can be generated for various body sites. Where other skin colourimetry systems are used, the Vf and Vh may be in units other than degrees.

Factors, such as age, gender, body weight (BW), standing height (SH), can be directly determined from a subject. Physical activity level (PAL) are well known to a person skilled in the art and can be readily measured. Daily dietary Vit-D intake (Dvd) and daily dietary calcium intake (Dca) can be estimated by a food frequency questionnaire. It shall be understood that the above factors can be expressed in different units, and as long as the unit of individual factor is consistent among the subjects, the function will work.

Among the factors, gender and season (i.e. the season when the skin colourimetry measurements are obtained) are two not expressed in values. Therefore, in order to create a function, these two factors can be differentially designated pre-set values.

In some embodiments, in season factors, summer is designated a value of “1” and winter is designated a value of “2”. It shall be understood that, in some embodiments where there are only two seasons (e.g. summer and winter) under consideration, the logistic regression model can be applied with the two seasons to be considered within the same logistic regression model. It shall be also understood that, in some embodiments where more than two seasons are considered, the logistic regression model can be evaluated with subgroup analysis, i.e. one at a time for each season. In this base, it still will be satisfactory with more than two seasons. Since for each season, a person skilled in the art can have a different logistic regression formula for predicting Vit-D status.

In some embodiments, in gender factors, male is designated a value of “1” and female is designated a value of “2”. It shall be understood that other designated pre-set values can also be used.

It shall be also understood that, besides Vf and Vh which are necessarily included in the factors, a person skilled in the art could make a selection among the other factors depending on actual needs and conditions.

Carrying out a logistic regression analysis of the method includes carrying out logistic regression analysis by using Vit-D status (“0” or “1”) as the dependent variable, and the factors or the transformed formats of the factors as the independent variables, thereby obtaining a function with regression coefficients for each of the independent variables. Logistic regression model is commonly used in the field of statistics and well known to a person skilled in the art. General guidelines for logistic regression analysis can be easily found, e.g. http://en.wikipedia.org/wiki/Logistic_regression, or Y H Chan, “Biostatistics 202: Logistic regression analysis, Singapore Med J 2004 Vol 45(4): 149” which is incorporated herein by reference in its entirety.

In brief, logistic regression analyzes how a dependent variable can be predicted by a list of independent variables. In the embodiments of the present application, the dependent variable is a dichotomous variable, i.e. Vit-D status as 1=Vit-D insufficiency and 0=Vit-D sufficiency. For example, a logistic equation may have the following format:

$${log}_{e} ( \frac{Pred}{1 - Pred} ) = α + {\sum }_{1}^{k} {β}_{i} {x}_{i}$$

wherein α is constant term,

βᵢ is the regression coefficient for an independent variable xᵢ,

xᵢ represent individual independent variables,

k represents the total number of independent variables,

Pred is the predicted probability used for determining the screening result of either Vit-D insufficiency or Vit-D sufficiency according to a pre-set cut-off threshold of Pred.

The function can be transformed to:

$$\frac{Pred}{1 - Pred} = {e}^{α + {\sum }_{1}^{k} {β}_{i} {x}_{i}}$$

$$Pred = \frac{1}{1 + {e}^{- ( α + {\sum }_{1}^{k} {β}_{i} {x}_{i} )}}$$

Logistic regression analysis can be performed by many computer programs, one example of which is SPSS software which is exemplarily used in the Examples of the present application.

Once a function is established, it can be used to screen Vit-D insufficiency by introducing the factors from a subject to be screened thereby generating a Pred, and comparing the calculated Pred with a pre-set cut-off threshold of Pred.

Determination of an appropriate pre-set cut-off threshold of Pred can be done according to the result from a logistic regression analysis. For example, from a logistic regression analysis, the sensitivity and specificity for each cut-off threshold can be generated. Thus, a person skilled in the art can consider the desired sensitivity and specificity (as high as possible) while making an appropriate balance between the sensitivity and specificity, and then determine pre-set cut-off threshold of Pred for individual solution. An exemplary determination of a pre-set cut-off threshold of Pred is demonstrated in the Examples. In some embodiments, the pre-set cut-off threshold of Pred is about 0.61.

In some embodiments, the population of interest is adolescent population in Hong Kong, and the obtained function is:

Logₑ(Pred/(1−Pred))=0.072(Vh)−0.095(Vf)−0.09(season)−0.297(gender)−0.005(BW/SH²)−0.29(age)+8.055.

In some embodiments, the population of interest is female adolescent population in Hong Kong with daily dietary Vit-D intake≦400 IU/day, and the obtained function is:

Logₑ(Pred/(1−Pred))=0.131(Vh)−0.162(Vf)−0.293(season)−0.104(BW/SH²)−0.358(age)+12.997.

In some embodiments, the population of interest is adolescent population in Hong Kong, and the obtained function is:

Logₑ(Pred/(1−Pred))=0.057(Vh)−0.087(Vf)−0.22(season)−0.015(gender)+0.007(BW)−0.034(SH)−0.203(age)−0.6(PAL)+13.388.

In a second aspect disclosed herein, there provided is a method for screening vitamin D (Vit-D) insufficiency in a subject, comprising

providing a function for screening vitamin D (Vit-D) insufficiency in a population that the subject is from according to the method as described in the first aspect,

obtaining a set of factors in the subject as defined in the function,

introducing the set of factors into the function thereby obtaining a Pred, and

comparing the calculated Pred with a pre-set cut-off threshold of Pred, wherein the calculated Pred≧the pre-set cut-off threshold of Pred indicates Vit-D insufficiency, and the calculated Pred<the pre-set cut-off threshold of Pred indicates Vit-D sufficiency.

It shall be understood that providing a function for screening vitamin D (Vit-D) insufficiency of the screening method includes using an established function for screening vitamin D (Vit-D) insufficiency in a population that the subject is from. In some embodiments, where there is no ready-to-use function for screening vitamin D (Vit-D) insufficiency in a population that the subject is from, providing a function includes establishing a corresponding function according to the method as described in the first aspect.

The procedure for obtaining a set of factors in the subject can be substantively the same as that described in the first aspect.

Introducing involves introducing the set of obtained factors into the function, thereby generating a Pred upon calculation. The introducing procedure would be readily understood by a person skilled in the art.

Comparing includes comparing the calculated Pred with a pre-set cut-off threshold of Pred, as described in the first aspect, and then generating a screening result.

In a third aspect disclosed herein, there provided is a device for screening vitamin D (Vit-D) insufficiency in a subject, comprising

a measuring module configured to measure and record constitutive skin melanin pigmentation measurement (Vf) and facultative skin melanin pigmentation measurement (Vh) in the subject based on skin colourimetry, wherein Vf is measured on the instep area, the inner aspect or the sole of the foot, or the heel of the subject, and Vh is measured on the dorsum of the hand, the fingers, the thumb or the wrist of the subject,

an inputting module configured to record one or more or all of age, season, gender, body weight (BW), standing height (SH), physical activity level (PAL), daily dietary Vit-D intake (Dvd) and daily dietary calcium intake (Dca) in the subject, or transformed formats of the factors, wherein, age, BW, SH, PAL, Dvd or Dca is determined from the subject, seasons are differentially designated pre-set values, and male and female are differentially designated pre-set values, and

an processing module configured to run a function for screening vitamin D (Vit-D) insufficiency in a population that the subject is from according to the method described in the first aspect and calculate a Pred.

In some embodiments, the device further comprises a comparing module configured to compare the calculated Pred with a pre-set cut-off threshold of Pred, wherein the calculated Pred≧the pre-set cut-off threshold of Pred indicates Vit-D insufficiency, and the calculated Pred<the pre-set cut-off threshold of Pred indicates Vit-D sufficiency.

The work of the measuring module can be done by a skin colourimeter. In some embodiments, the measuring module works based on Individual Typology Angle (ITA) measure, e.g. L*a*b* colour system, as demonstrated in the Examples of the present application.

The inputting module is configured to record the confounding factors besides Vf and Vh.

The processing module configured to run a function according to the method described in the first aspect, into which the Vf and Vh measured and recorded by the measuring module and the factors recorded by the inputting module are to be introduced, and calculate a Pred. In some embodiments, the processing module includes a storage submodule configured to store functions that have been established for screening Vit-D insufficiency in various populations. In some embodiments, the processing module includes an inputting submodule configured to store a function input by a user.

It shall be understood that the comparing module is optional, since the comparing procedure can be done by a person skilled in the art by comparing the calculated Pred with a pre-set cut-off threshold of Pred. In some embodiments, the comparing module is integrated into the processing module.

In some embodiments, all the modules are incorporated into a skin colourimetry system, e.g. a skin colourimeter. In this case, the device can be manufactured with modifications to the manufacturing process of a skin colourimeter.

In a fourth aspect disclosed herein, there provided is a computer product comprising a computer readable medium storing a plurality of instructions for carrying out the method of the first and/or the second aspect.

### EXAMPLE

The Example below is provided with the only purpose of illustration, but not intended to make any limitation to the inventions described herein.

### Materials and Methods:

This was an observational study using stratified clustered random sampling with secondary schools being the clusters and subjects were recruited according to distribution of the population within Hong Kong. Subjects were invited by letters issued through local school administrators and recruitment was carried out according to the following criteria:

Inclusion Criteria:

12 to 16 years old Chinese with no known chronic diseases affecting growth, calcium nor Vit-D metabolism were recruited. In particular, they were physically assessed by a qualified doctor to rule out medical disorders.

Exclusion Criteria:—

1. Subjects suffering from any medical conditions that were known to affect bone metabolism such as genetic diseases, chromosomal defects, autoimmune disorders, endocrine disturbances including parathyroid and thyroid diseases, acute or chronic renal or liver diseases, malignancies or any disuse conditions.

2. Subjects who have received treatment that affected bone metabolism such as bisphosphonates and steroid.

3. Smoker or drinker.

Vit-D status was assessed according to the conceptual framework of European Commission Concerted Action on Functional Food Science in Europe (14) and the biomarkers for Vit-D status, namely 25(OH)Vit-D was checked. Vit D insufficiency was diagnosed when 25(OH)Vit-D≦50 nmol/L(1, 15).

Ethical approval was obtained from the joint CUHK-NTEC Clinical Research Ethics Committee (CREC, the IRB of our hospital) before the study was started. An initial interview with the subject was conducted to explain the study. The tests that needed to be done were fully explained. Questions from the subjects and their guardians were answered up to their satisfaction. A written informed consent was obtained in the presence of their guardians.

Investigations and Measurements:—

1. Skin Colourimetry

The constitutive and facultative skin color was measured by a Spectrophotometer CM-2300d (Konica-Minolta). This instrument measured skin reflectance of light over the visible light wavelength spectrum from 360 to 740 nm, and reported data according to the Commission Internationale de l'Eclairage recommended L*a*b* system, in which a higher L* value represented lighter (or brighter) skin that contains less UV absorbing melanin(16, 17). Skin pigmentation was best evaluated quantitatively with the L* vs. b*correlation expressed with a single parameter, the Individual Typology Angle (ITA in degrees), calculated according to the following formula:

ITA=[Tan⁻¹((L−50)/b)]×180/π

Skin color has been classified using ITA as very light>55>light>41>intermediate>28>tanned>10>brown>-30>dark(12, 18).

Three constitutive and three facultative skin locations were evaluated to decide the best location for screening Vit-D insufficiency, namely:

For Constitutive Skin Colour:

a. inner area of the dominant and non-dominant arm (between upper and middle third)

b. the mid-inguinal point of the dominant and non-dominant leg (mid-point between anterior superior iliac spine and pubic tubercle)

c. the instep area of the dominant and non-dominant foot (mid-point of the instep area)

For Facultative Skin Colour:

a. the right and left cheek (most prominent area of malar region)

b. the outer forearm of the dominant and non-dominant arm (with forearm supinated, lateral most part between the proximal and the adjacent one quarter)

c. the dorsum of the dominant and non-dominant hand (over the dorsum of the first web space, avoiding any underlying vein)

The raters doing the skin colour measurement were blinded to the Vit-D status of the subjects.

2. Serum 25(OH)Vit-D Assay:—

Serum 25(OH)Vit-D is the major determinant of Vit-D status (19). Non-fasting blood was taken on the same day of skin colourimetry measurement and the assay was performed using the gold standard of liquid chromatography tandem mass spectrometry (LCTMS) with details of method described previously(20, 21). Limits of quantitation were 10 nmol/L and the linearity was up to 750 nmol/L.

3. Food Frequency Questionnaire:

Evaluation of habitual dietary intake will be based on retrospective means of assessment. A modified Food Frequency Questionnaire (FFQ) based on data obtained in the Hong Kong Adult Dietary Survey in 1995 (22) will be used. The FFQ had been validated with the basal metabolic rate calculation and the 24-hour sodium/creatinine and potassium/creatinine analysis (23). Subjects will be asked about their usual frequency and consumption in the past twelve months from the food list. Standard portion size will be listed and a food photo album is provided to assist assessment. Daily nutrient intake including vitamin D and calcium is calculated by the Food Processor Nutrition analysis and Fitness software version 7.9 (Esha Research, Salem, USA), with addition of composition of some local foods based on food composition table from China (24) and commonly encountered Vit-D supplements available in the market(25).

4. Anthropometric and Leg Dominance Assessment

Anthropometric parameters including body weight and standing height were measured with standard stadiometry techniques. Body mass index (BMI=body weight/standing height², in kg/m²) was calculated. Leg dominance was determined by asking the subject to indicate which leg would be used to kick a ball placed in front of the subjects. The leg that kicked the ball was regarded as the dominant leg (25, 26).

### Statistical Analysis:—

The spread of data was tested for normality. For data that was normally distributed, the numerical data were expressed as mean±SD. Otherwise they were expressed as median (interquartile range). A multiple linear regression model was used to evaluate the strength of correlation between 25(OH)Vit-D level as the dependent variable and the facultative and constitutive skin colour, one skin location at a time, with control of confounding from season, gender, body mass index (BMI) and age(27). The constitutive and facultative skin location giving the best correlation with the highest R-square was selected for further analysis. Logistic regression analysis was used to find out the prognostic factors predicting Vit-D insufficiency(28). The Hosmer and Lemeshow goodness-of-fit statistics was used for model fit analysis(29). A receiver operating characteristic curve (ROC curve) was plotted to list the accuracy of the regression model(30). The sensitivity and specificity of the predictive model were obtained from the ROC curve. The inter-rater reliability was assessed with Intra-class correlation coefficients (2,1). SPSS Version 20 (IBM Corporation, NY, USA) was used for statistical analysis. Significance was defined by a two-sided alpha level of <0.05.

### Results:

143 adolescents were recruited in summer (98 males, 45 females) and 97 in winter (55 males and 42 females). The mean age was 14.5+/−1.16 years old. The mean serum 25(OH)Vit-D level was 43.4+/−13.8 nmol/l. The median dietary Vit-D intake was 143 (interquartile range=185) IU/day. Details of demographic and anthropometric data of recruited subjects are depicted in Table 1.

The inter-rater reliability as assessed by intra-class correlation coefficient (ICC) and precision in terms of percentage coefficient of variation (CV %) for ITA measurement at various skin locations are depicted in Table 2. ICC ranged from 0.802 to 0.975. The CV % at various locations ranged from 1.51% to 5.86% with the exception of 8.77% and 15.92% respectively for the outer forearm of dominant and non-dominant arm.

The ITA data for various skin locations were depicted in Table 3. ITA for females was higher than male indicating the skin colours of females were significantly lighter than males at all skin locations (p<0.001).

The multiple linear regression model was used to evaluate the strength of correlation between serum 25(OH)Vit-D levels and ITA at various skin location, analyzing one at a time. The results indicated the most significant constitutive and facultative skin locations were respectively the instep of the non-dominant foot (p=0.021) and the dorsum of the non-dominant hand (p=0.008) (Table 4). To obtain a predictive equation, the ITA for both sites, namely ITA[NDinstep] and ITA[NDdorsum], were then put into the logistic regression model for further analysis with other confounding factors, namely season (summer or winter), gender (male or female), BMI (kg/m²) and age (in years). Results indicated both ITA[NDinstep] (p=0.001) and ITA[NDdorsum] (p<0.001) were significant and independent factors for predicting Vit-D insufficiency and the final predictive formulae (F-VDI) was as follows:

Log it Pred=Log(Pred/(1−Pred))=0.072(ITA[NDdorsum])−0.095(ITA[NDinstep])−0.09(season)−0.297(gender)−0.005(BMI)−0.29(age)+8.055(where Pred is the predicted probability)

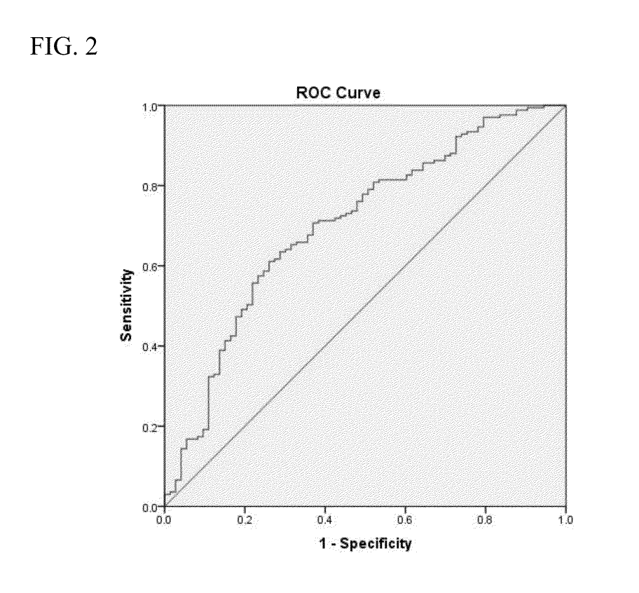

Hosmer and Lemeshow Test gave a p-value of 0.697 indicating goodness of fit for the model. From the logistic regression analysis, the ROC curve was generated, as shown in FIG. 2.

During the analysis, the table (see below) showing the sensitivity and (1-specificity) for each cut-off thresholds values was calculated.

Test Result Variable(s): Predicted probability

| Positive if Greater Than or Equal To^{a} | Sensitivity | 1 - Specificity |
|---|---|---|
| 0E−7 | 1.000 | 1.000 |
| .1661346 | 1.000 | .986 |
| .1862359 | 1.000 | .973 |
| .2345923 | 1.000 | .959 |
| .2759340 | 1.000 | .945 |
| .2853253 | .994 | .945 |
| .3000067 | .994 | .932 |
| .3195097 | .994 | .918 |
| .3341443 | .994 | .904 |
| .3406752 | .988 | .904 |
| .3602228 | .988 | .890 |
| .3813012 | .988 | .877 |
| .3985256 | .982 | .877 |
| .4159919 | .976 | .877 |
| .4234393 | .976 | .863 |
| .4405237 | .976 | .849 |
| .4572213 | .976 | .836 |
| .4600769 | .970 | .836 |
| .4648751 | .970 | .822 |
| .4699871 | .970 | .808 |
| .4712171 | .970 | .795 |
| .4740746 | .964 | .795 |
| .4784388 | .958 | .795 |
| .4875925 | .952 | .795 |
| .4973960 | .946 | .795 |
| .5006380 | .946 | .781 |
| .5056872 | .940 | .781 |
| .5112734 | .934 | .781 |
| .5122878 | .934 | .767 |
| .5137810 | .934 | .753 |
| .5192607 | .928 | .753 |
| .5262640 | .928 | .740 |
| .5315510 | .922 | .740 |
| .5351928 | .922 | .726 |
| .5378279 | .916 | .726 |
| .5403733 | .910 | .726 |
| .5414158 | .904 | .726 |
| .5459199 | .898 | .726 |
| .5511056 | .892 | .726 |
| .5532937 | .886 | .726 |
| .5547670 | .880 | .726 |
| .5555745 | .880 | .712 |
| .5570673 | .874 | .712 |
| .5598216 | .874 | .699 |
| .5620175 | .868 | .699 |
| .5622670 | .862 | .699 |
| .5624274 | .862 | .685 |
| .5641806 | .862 | .671 |
| .5669941 | .856 | .671 |
| .5682023 | .856 | .658 |
| .5707497 | .856 | .644 |
| .5737624 | .850 | .644 |
| .5752774 | .844 | .644 |
| .5780670 | .838 | .644 |
| .5828694 | .838 | .630 |
| .5870423 | .838 | .616 |
| .5897949 | .832 | .616 |
| .5923693 | .826 | .616 |
| .5941204 | .826 | .603 |
| .5956673 | .820 | .603 |
| .5970234 | .814 | .603 |
| .5983981 | .814 | .589 |
| .5993652 | .814 | .575 |
| .5999990 | .814 | .562 |
| .6026534 | .814 | .548 |
| .6051836 | .814 | .534 |
| .6073353 | .808 | .534 |
| .6098242 | .808 | .521 |
| .6114566 | .802 | .521 |
| .6159132 | .796 | .521 |
| .6202269 | .790 | .521 |
| .6229426 | .790 | .507 |
| .6269837 | .784 | .507 |
| .6298732 | .778 | .507 |
| .6308713 | .778 | .493 |
| .6314065 | .772 | .493 |
| .6319949 | .766 | .493 |
| .6342825 | .760 | .493 |
| .6365140 | .760 | .479 |
| .6387539 | .754 | .479 |
| .6441351 | .749 | .479 |
| .6476472 | .743 | .479 |
| .6491472 | .737 | .479 |
| .6507251 | .737 | .466 |
| .6520076 | .731 | .466 |
| .6535562 | .731 | .452 |
| .6545790 | .725 | .452 |
| .6553908 | .725 | .438 |
| .6598129 | .719 | .438 |
| .6645619 | .719 | .425 |
| .6651920 | .713 | .425 |
| .6666624 | .713 | .411 |
| .6685048 | .713 | .397 |
| .6691302 | .713 | .384 |
| .6708313 | .707 | .384 |
| .6724037 | .707 | .370 |
| .6727970 | .701 | .370 |
| .6754616 | .695 | .370 |
| .6786344 | .689 | .370 |
| .6810331 | .683 | .370 |
| .6841585 | .677 | .370 |
| .6864820 | .677 | .356 |
| .6879506 | .671 | .356 |
| .6890739 | .665 | .356 |
| .6898699 | .659 | .356 |
| .6908748 | .659 | .342 |
| .6949941 | .659 | .329 |
| .6986374 | .653 | .329 |
| .7019675 | .653 | .315 |
| .7055180 | .647 | .315 |
| .7075684 | .641 | .315 |
| .7095743 | .641 | .301 |
| .7109155 | .635 | .301 |
| .7142970 | .635 | .288 |
| .7172015 | .629 | .288 |
| .7182560 | .623 | .288 |
| .7190412 | .617 | .288 |
| .7197993 | .617 | .274 |
| .7208996 | .611 | .274 |
| .7223867 | .611 | .260 |
| .7243250 | .605 | .260 |
| .7253772 | .599 | .260 |
| .7260464 | .593 | .260 |
| .7281221 | .587 | .260 |
| .7321195 | .587 | .247 |
| .7348537 | .581 | .247 |
| .7360280 | .575 | .247 |
| .7383643 | .575 | .233 |
| .7397950 | .569 | .233 |
| .7399864 | .563 | .233 |
| .7418375 | .557 | .233 |
| .7438738 | .557 | .219 |
| .7443322 | .551 | .219 |
| .7446110 | .545 | .219 |
| .7447857 | .539 | .219 |
| .7468636 | .533 | .219 |
| .7494382 | .527 | .219 |
| .7507792 | .521 | .219 |
| .7515980 | .515 | .219 |
| .7518689 | .509 | .219 |
| .7528268 | .503 | .219 |
| .7536443 | .503 | .205 |
| .7553001 | .497 | .205 |
| .7577498 | .491 | .205 |
| .7587061 | .491 | .192 |
| .7589917 | .485 | .192 |
| .7601305 | .479 | .192 |
| .7613076 | .473 | .192 |
| .7618615 | .473 | .178 |
| .7622880 | .467 | .178 |
| .7642987 | .461 | .178 |
| .7675722 | .455 | .178 |
| .7692962 | .449 | .178 |
| .7728610 | .443 | .178 |
| .7766941 | .437 | .178 |
| .7776107 | .431 | .178 |
| .7779579 | .425 | .178 |
| .7781453 | .425 | .164 |
| .7811916 | .419 | .164 |
| .7841383 | .413 | .164 |
| .7850876 | .413 | .151 |
| .7873516 | .407 | .151 |
| .7898127 | .401 | .151 |
| .7918428 | .395 | .151 |
| .7928244 | .389 | .151 |
| .7939309 | .389 | .137 |
| .7956760 | .383 | .137 |
| .7967842 | .377 | .137 |
| .7976080 | .371 | .137 |
| .7984437 | .365 | .137 |
| .7999432 | .359 | .137 |
| .8016189 | .353 | .137 |
| .8025462 | .347 | .137 |
| .8036000 | .341 | .137 |
| .8050025 | .335 | .137 |
| .8071923 | .329 | .137 |
| .8108884 | .329 | .123 |
| .8134171 | .323 | .123 |
| .8144612 | .323 | .110 |
| .8151504 | .317 | .110 |
| .8177106 | .311 | .110 |
| .8203491 | .305 | .110 |
| .8215600 | .299 | .110 |
| .8243036 | .293 | .110 |
| .8262814 | .287 | .110 |
| .8280265 | .281 | .110 |
| .8295359 | .275 | .110 |
| .8313587 | .269 | .110 |
| .8332785 | .263 | .110 |
| .8338910 | .257 | .110 |
| .8365710 | .251 | .110 |
| .8389409 | .246 | .110 |
| .8395125 | .240 | .110 |
| .8405694 | .234 | .110 |
| .8413380 | .228 | .110 |
| .8422051 | .222 | .110 |
| .8430981 | .216 | .110 |
| .8436040 | .210 | .110 |
| .8440262 | .204 | .110 |
| .8442139 | .198 | .110 |
| .8447168 | .192 | .110 |
| .8458543 | .192 | .096 |
| .8472721 | .186 | .096 |
| .8484411 | .180 | .096 |
| .8506746 | .174 | .096 |
| .8526715 | .174 | .082 |
| .8528776 | .168 | .082 |
| .8544352 | .168 | .068 |
| .8559810 | .168 | .055 |
| .8607699 | .162 | .055 |
| .8658978 | .156 | .055 |
| .8670486 | .150 | .055 |
| .8685783 | .144 | .055 |
| .8707782 | .144 | .041 |
| .8724899 | .138 | .041 |
| .8732959 | .132 | .041 |
| .8744664 | .126 | .041 |
| .8752236 | .120 | .041 |
| .8760009 | .114 | .041 |
| .8790652 | .108 | .041 |
| .8831760 | .102 | .041 |
| .8855324 | .096 | .041 |
| .8867568 | .090 | .041 |
| .8877439 | .084 | .041 |
| .8891339 | .078 | .041 |
| .8902453 | .072 | .041 |
| .8913111 | .066 | .041 |
| .8927849 | .066 | .027 |
| .8953087 | .060 | .027 |
| .8986496 | .054 | .027 |
| .9070246 | .048 | .027 |
| .9161382 | .042 | .027 |
| .9185100 | .036 | .027 |
| .9219159 | .036 | .014 |
| .9270941 | .030 | .014 |
| .9325026 | .030 | .000 |
| .9360148 | .024 | .000 |
| .9383566 | .018 | .000 |
| .9426407 | .012 | .000 |
| .9552207 | .006 | .000 |
| 1.0000000 | .000 | .000 |

The area under curve (AUC) was 0.70 (95% CI: 0.63-0.78) showing satisfactory accuracy with a sensitivity of 0.80 and a specificity of 0.48 at a predicted probability cutoff of 0.61 (see underlined part in the table). The overall screening test results were summarized in Table 5. The positive predictive value was 77.9% and the negative predictive value was 51.5%.

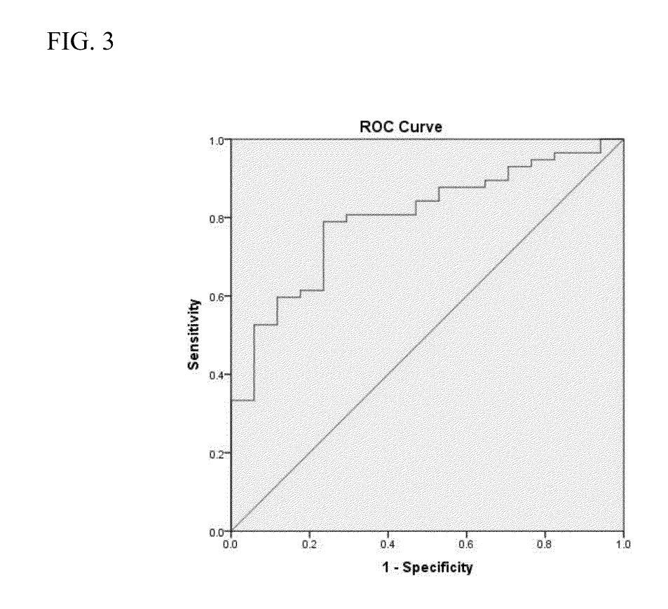

Subgroup analysis for females with daily dietary Vit-D intake less than 400 IU indicated the predictive model had an even better ROC curve with AUC of 0.80 (95% CI: 0.69-0.91, FIG. 3) and a sensitivity of 0.81 and a specificity of 0.71 at a predicted probability cutoff of 0.74.

As a summary of the Examples disclosed herein, we firstly to compare six facultative and six constitutive skin locations on their strength of correlation with serum 25(OH)Vit-D levels (Table 4) and secondly evaluate their roles in predicting Vit-D insufficiency. Results indicated the locations with the strongest correlation with serum 25(OH)Vit-D levels were the instep of the non-dominant foot (for constitutive skin) and the dorsum of the non-dominant hand (for facultative skin). Their respective CV % for measurement were 2.31% and 2.71% indicating satisfactory precision of measurement. In spite of these desirable features and to the best of our knowledge, skin colourimetry involving the instep of the non-dominant foot and the dorsum of the non-dominant hand has not been reported before. In addition, this study indicated the correlation with serum 25(OH)Vit-D did not reach statistical significance for the inner arm, face and outer forearm measurements, and notably, the CV % for outer forearm measurement were 8.77% for the dominant side and 15.92% for the non-dominant side indicating suboptimal precision of measurement the interpretation of which should be made with cautions. It is therefore desirable to include instep area of foot and dorsum of hand in addition to other locations as needed for clinical application or research studies involving skin colourimetry measurement.

Given the statistical significant correlation with 25(OH)Vit-D and the satisfactory precision for measurement, ITA at the instep of the non-dominant foot(ITA[NDinstep]) and the dorsum of the non-dominant hand(ITA[NDdorsum]) were further analyzed with the logistic regression model for evaluation of their role in predicting Vit-D insufficiency. Results indicated that both ITA[NDinstep] and ITA[NDdorsum] were significant and independent predicting factors for Vit-D insufficiency (p=0.001 and p<0.001 respectively). The predictive formulae, namely the F-VDI, was derived with incorporation of ITA[NDinstep], ITA[NDdorsum] and other physiological factors including season, gender, body mass index (BMI) and age. The ROC curve as shown in FIG. 2 showed an area under curve (AUC) of 0.70 (95% CI: 0.63-0.78) indicating satisfactory accuracy with a sensitivity of 0.80 and a specificity of 0.48 at a predicted probability cutoff of 0.61.

Dietary intake was one of the sources for Vit-D. It was interesting to note that with subgroup analysis on females confined to those with dietary Vit-D intake less than 400 IU per day, an even better ROC curve was obtained. The AUC was 0.80 (95% CI: 0.69-0.91, FIG. 3) with a sensitivity of 0.81 and a specificity of 0.71 at a predicted probability cutoff of 0.74.

Accordingly, it is the first time that inventors of the present application use skin colourimetry to screen for Vit-D insufficiency. The procedure includes measurement of the constitutive and facultative skin melanin pigmentation with a skin colourimetry system at the instep of the non-dominant foot and the dorsum of the non-dominant hand respectively. In case of overlying skin lesions or prominent veins that preclude proper measurement, the neighbouring skin can be measured, namely the inner aspect and the sole of the foot and heel, and the dorsum of the hand (including fingers and thumb). The predicted probability can be calculated using the formula F-VDI incorporating ITA[NDinstep], ITA[NDdorsum], season, gender, body mass index (BMI) and age. The predicted probability can then be used to predict Vit-D insufficiency according to a pre-set cutoff threshold. Once Vit-D insufficiency is screened positive, further confirmatory investigations could be considered according to individual settings.

The subjects recruited in the Examples disclosed herein were confined to Chinese adolescents and the investigation was performed with one specific model of colourimeter. Chromatic properties of skin and its colourimetric measurement could vary with different target populations of different age groups and different ethnic backgrounds thus affecting the regression coefficients depicted in the F-VDI. Re-validation of the F-VDI with fine adjustment of its regression coefficients should be considered when a new target population is under test. Likewise, similar re-validation should be considered when a new model of skin colourimetry systems is deployed. In addition, further studies with larger sample sizes would be important to allow inclusion of other physiological parameters including dietary Vit-D intake and dietary Calcium intake for further optimization of screening results for Vit-D insufficiency using the principles of skin colourimetry.

The present disclosure proves that the skin colourimetry disclosed herein could be used for screening Vit-D insufficiency. During the measurement, the required information including season, gender, BMI and age can be easily obtained. Together with ITA to be swiftly measured over the instep of foot and dorsum of hand within seconds, the results indicating the likelihood of Vit-D insufficiency can be obtained thus justifying further confirmatory investigation according to individual settings. With dissemination of this reliable and affordable screening tool for Vit-D insufficiency, individual awareness and early detection of the condition at its asymptomatic stage can be achieved thus helping to tackle the epidemic of Vit-D insufficiency for the general population.

TABLE 1
Demographic, anthropometric and serum
25(OH)Vit-D data for both genders

| | Male | female |
|---|---|---|
| | (mean ± SD) | (mean ± SD) |
| Age (year) | 14.4 ± 1.1 | 14.6 ± 1.2 |
| Body weight (kg) | 53.9 ± 12.4 | 49.8 ± 9.3 |
| Standing height (cm) | 164.7 ± 9.3 | 157.1 ± 6.5 |
| BMI (kg/m²) | 19.7 ± 3.5 | 20.1 ± 3.4 |
| 25(OH)Vit-D (nmol/L) | 43.8 ± 14.0 | 42.5 ± 13.6 |

TABLE 2
Inter-rater reliability and precision in terms of CV
%** for ITA measurement at various skin locations

| | | |
|---|---|---|
| | Inter-rater | |
| Skin location for ITA | reliability* | CV %** |

Constitutive skin

| | | |
|---|---|---|
| Inner area of dominant arm | 0.868 | 1.51 |
| Inner area of non-dominant arm | 0.889 | 1.53 |
| Mid-inguinal point of dominant leg | 0.896 | 3.81 |
| Mid-inguinal point of non-dominant leg | 0.820 | 2.89 |
| Instep of dominant foot | 0.926 | 2.03 |
| Instep of non-dominant foot | 0.851 | 2.31 |

Facultative skin

| | | |
|---|---|---|
| Right cheek | 0.834 | 3.57 |
| Left cheek | 0.910 | 2.39 |
| Outer forearm of dominant arm | 0.856 | 8.77 |
| Outer forearm of non-dominant arm | 0.975 | 15.92 |
| Dorsum of dominant hand | 0.958 | 5.86 |
| Dorsum of non-dominant hand | 0.802 | 2.71 |

*intra-class correlation coefficient (2, 1) is used for analysis
**CV % refers to percentage coefficient of variation

TABLE 3
Skin colourimetry measurements (ITA) for male and female

| | | | |
|---|---|---|---|
| | Male | female | |
| ITA (in degrees) | (mean ± SD) | (mean ± SD) | p-value * |

Constitutive skin

| | | | |
|---|---|---|---|
| Inner area of dominant arm | 38.6 ± 8.8 | 45.6 ± 7.2 | <0.001** |
| Inner area of non-dominant arm | 39.1 ± 8.9 | 45.2 ± 7.4 | <0.001** |
| Mid-inguinal point of dominant | 34.1 ± 9.7 | 39.7 ± 8.1 | <0.001** |
| leg | | | |
| Mid-inguinal point of | 34.6 ± 9.2 | 40.1 ± 8.1 | <0.001** |
| non-dominant leg | | | |
| Instep of dominant foot | 45.9 ± 6.8 | 51.5 ± 5.4 | <0.001** |
| Instep of non-dominant foot | 45.1 ± 7.1 | 50.8 ± 5.6 | <0.001** |

Facultative skin

| | | | |
|---|---|---|---|
| Right cheek | 30.8 ± 7.7 | 38.3 ± 6.7 | <0.001** |
| Left cheek | 30.3 ± 7.6 | 37.6 ± 6.3 | <0.001** |
| Outer forearm of dominant arm | 13.2 ± 10.3 | 23.6 ± 9.5 | <0.001** |
| Outer forearm of non-dominant | 14.0 ± 10.0 | 25.2 ± 9.4 | <0.001** |
| arm | | | |
| Dorsum of dominant hand | 23.5 ± 9.3 | 33.4 ± 8.5 | <0.001** |
| Dorsum of non-dominant hand | 22.8 ± 9.3 | 32.6 ± 9.2 | <0.001** |

* p-value from comparison between male and female using independent sample t-test
**p < 0.001

TABLE 4
Multiple linear regression analysis for
initial screening of ITA parameters

| | | |
|---|---|---|
| | % contribution | |
| Skin Location for ITA | to R² from | p-value for the regression |
| parameter measurement | ITA parameter | coefficient for ITA |

Constitutive skin

| | | |
|---|---|---|
| Inner area of dominant arm | 1.8 | 0.616 |
| Inner area of non-dominant | 0.0 | 0.882 |
| arm | | |
| Mid-inguinal point of | 0.0 | 0.957 |
| dominant leg | | |
| Mid-inguinal point of | 0.0 | 0.826 |
| non-dominant leg | | |
| Instep of dominant foot | 20.6 | 0.056 |
| Instep of non-dominant foot | 28.0 | 0.021* |

Facultative skin

| | | |
|---|---|---|
| Right cheek | 0.0 | 0.797 |
| Left cheek | 6.9 | 0.305 |
| Outer forearm of dominant | 20.6 | 0.064 |
| arm | | |
| Outer forearm of | 15.6 | 0.119 |
| non-dominant arm | | |
| Dorsum of dominant hand | 14.3 | 0.140 |
| Dorsum of non-dominant | 33.3 | 0.008* |
| hand | | |

*p < 0.05
Dependent variable: serum 25(OH)Vit-D
Independent variable: season, gender, BMI, age, ITA
R²: coefficient of multiple determination

TABLE 5
Screening test results assuming a predicted
probability cutoff of 0.61

| Vit-D status | Vit-D insufficient | Vit-D sufficient | Total |
|---|---|---|---|
| Vit-D insufficiency | 134 | 38 | 172 |
| screening positive | | | |
| Vit-D insufficiency | 33 | 35 | 68 |
| screening negative | | | |
| Total | 167 | 73 | 240 |

All of the patents, patent applications and non-patent publications referred to in this specification are incorporated herein by reference in their entirety.

From the foregoing it will be appreciated that, although specific embodiments of the application have been described herein for purposes of illustration, various modifications or variations may be made by those skilled in the art without deviating from the spirit and scope of the appended claims.

### REFERENCES

1. Institute of Medicine. Edtion ed. In: Ross A C, Taylor C L, Yaktine A L, Del Valle H B, eds. Dietary Reference Intakes for Calcium and Vitamin D. Washington (DC), 2011.
2. Hilger J, Friedel A, Herr R, Rausch T, Roos F, Wahl D A, Pierroz D D, Weber P, Hoffmann K. A systematic review of vitamin D status in populations worldwide. The British journal of nutrition 2014; 111(1):23-45. doi: 10.1017/S0007114513001840.
3. Hossein-nezhad A, Holick M F. Vitamin D for health: a global perspective. Mayo Clinic proceedings 2013; 88(7):720-55. doi: 10.1016/j.mayocp.2013.05.011.
4. Millen A E, Wactawski-Wende J, Pettinger M, Melamed M L, Tylaysky F A, Liu S, Robbins J, LaCroix A Z, LeBoff M S, Jackson R D. Predictors of serum 25-hydroxyvitamin D concentrations among postmenopausal women: the Women's Health Initiative Calcium plus Vitamin D clinical trial. Am J Clin Nutr 2010; 91(5):1324-35. doi: 10.3945/ajcn.2009.28908.
5. McCarty C A. Sunlight exposure assessment: can we accurately assess vitamin D exposure from sunlight questionnaires? Am J Clin Nutr 2008; 87(4):10975-101S.
6. Millen A E, Bodnar L M. Vitamin D assessment in population-based studies: a review of the issues. Am J Clin Nutr 2008; 87(4):1102S-5S.
7. Webb A. Measuring U V radiation: a discussion of dosimeter properties, uses and limitations. Journal of Photochemistry and Photobiology B: Biology 1995; 31(1-2):9-13.
8. Sohl E, Heymans M W, de Jongh R T, den Heijer M, Visser M, Merlijn T, Lips P, van Schoor N M. Prediction of vitamin D deficiency by simple patient characteristics. Am J Clin Nutr 2014; 99(5):1089-95. doi: 10.3945/ajcn.113.076430.
9. Tran B, Armstrong B K, McGeechan K, Ebeling P R, English D R, Kimlin M G, Lucas R, van der Pols J C, Venn A, Gebski V, et al. Predicting vitamin D deficiency in older Australian adults. Clinical endocrinology 2013; 79(5):631-40. doi: 10.1111/cen.12203.
10. Bjorn Jensen C, Thorne-Lyman A L, Vadgard Hansen L, Strom M, Odgaard Nielsen N, Cohen A, Olsen S F. Development and validation of a vitamin D status prediction model in Danish pregnant women: a study of the Danish National Birth Cohort. PloS one 2013; 8(1):e53059. doi: 10.1371/journal.pone.0053059.
11. Bertrand K A, Giovannucci E, Liu Y, Malspeis S, Eliassen A H, Wu K, Holmes M D, Laden F, Feskanich D. Determinants of plasma 25-hydroxyvitamin D and development of prediction models in three US cohorts. The British journal of nutrition 2012; 108(10):1889-96. doi: 10.1017/S0007114511007409.
12. Rockell J E, Skeaff C M, Williams S M, Green T J. Association between quantitative measures of skin color and plasma 25-hydroxyvitamin D. Osteoporos Int 2008; 19(11):1639-42. doi: 10.1007/s00198-008-0620-4.
13. Palermo N E, Holick M F. Vitamin D, bone health, and other health benefits in pediatric patients. Journal of pediatric rehabilitation medicine 2014; 7(2):179-92. doi: 10.3233/PRM-140287.
14. Scientific concepts of functional foods in Europe. Consensus document. Br J Nutr 1999; 81 Suppl 1:S1-27.
15. Need A G. Bone resorption markers in vitamin D insufficiency. Clinica chimica acta; international journal of clinical chemistry 2006; 368(1-2):48-52.
16. Taylor S, Westerhof W, Im S, Lim J. Noninvasive techniques for the evaluation of skin color. J Am Acad Dermatol 2006; 54(5 Suppl 2):5282-90. doi: 10.1016/j.jaad.2005.12.041.
17. Pierard G E. EEMCO guidance for the assessment of skin colour. J Eur Acad Dermatol Venereol 1998; 10(1):1-11.
18. Del Bino S, Sok J, Bessac E, Bernerd F. Relationship between skin response to ultraviolet exposure and skin color type. Pigment Cell Res 2006; 19(6):606-14. doi: 10.1111/j.1600-0749.2006.00338.x.
19. Holick M F. Optimal vitamin d status for the prevention and treatment of osteoporosis. Drugs & aging 2007; 24(12):1017-29.
20. Roth H J, Schmidt-Gayk H, Weber H, Niederau C. Accuracy and clinical implications of seven 25-hydroxyvitamin D methods compared with liquid chromatography-tandem mass spectrometry as a reference. Annals of clinical biochemistry 2008; 45(Pt 2):153-9.
21. Ong L, Saw S, Sahabdeen N B, Tey K T, Ho C S, Sethi S K. Current 25-hydroxyvitamin D assays: do they pass the test? Clinica chimica acta; international journal of clinical chemistry 2012; 413(13-14):1127-34. doi: 10.1016/j.cca.2012.03.009.
22. Leung S S F, Ho S C, Woo J, Lam T H, Janus E D. Hong Kong Adult Dietary Survey 1995. Hong Kong: Department of Paediatrics, The Chinese University of Hong Kong, 1997.
23. Woo J, Leung S S F, Ho S C, Lam T H, Janus E D. A food frequency questionnaire for use in the Chinese population in Hong Kong: Description and examination of validity. Nutr Res 1997; 17:1633-41.
24. Institute of Nutrition and Food Safety. China Food Composition. People's Republic of China: Peking University Medical Press, 2002.
25. Lam T P, Ng B K, Cheung L W, Lee K M, Qin L, Cheng J C. Effect of whole body vibration (WBV) therapy on bone density and bone quality in osteopenic girls with adolescent idiopathic scoliosis: a randomized, controlled trial. Osteoporos Int 2013; 24(5):1623-36. doi: 10.1007/s00198-012-2144-1.
26. Alonso A C, Brech G C, Bourquin A M, Greve J M. The influence of lower-limb dominance on postural balance. Sao Paulo Med J 2011; 129(6):410-3. doi: S1516-31802011000600007 [pii].
27. Prentice A. Vitamin D deficiency: a global perspective. Nutr Rev 2008; 66(10 Suppl 2):S153-64. doi: 10.1111/j.1753-4887.2008.00100.x.
28. Hosmer D W, Lemeshow S. Applied Logistic Regression. New York Wiley, 2000.
29. Hosmer D W, Hosmer T, Le Cessie S, Lemeshow S. A comparison of goodness-of-fit tests for the logistic regression model. Statistics in medicine 1997; 16(9):965-80.
30. Metz C E. Basic principles of ROC analysis. Seminars in nuclear medicine 1978; 8(4):283-98.
31. Thieden E, Philipsen P A, Wulf H C. Ultraviolet radiation exposure pattern in winter compared with summer based on time-stamped personal dosimeter readings. Br J Dermatol 2006; 154(1):133-8. doi: 10.1111/j.1365-2133.2005.06961.x.
32. Seckmeyer G, Klingebiel M, Riechelmann S, Lohse I, McKenzie R L, Liley J B, Allen M W, Siani A M, Casale G R. A critical assessment of two types of personal U V dosimeters. Photochem Photobiol 2012; 88(1):215-22. doi: 10.1111/j.1751-1097.2011.01018.x.
33. Osborne D L, Weaver C M, McAbe L D, McCabe G M, Novotny R, Boushey C, Savaiano D A. Tanning predicts bone mass but not structure in adolescent females living in Hawaii. American journal of human biology: the official journal of the Human Biology Council 2011; 23(4):470-8. doi: 10.1002/ajhb.21158.
34. Macdonald H M, Mavroeidi A, Aucott L A, Diffey B L, Fraser W D, Ormerod A D, Reid D M. Skin color change in Caucasian postmenopausal women predicts summer-winter change in 25-hydroxyvitamin D: findings from the ANSAViD cohort study. J Clin Endocrinol Metab 2011; 96(6):1677-86. doi: 10.1210/jc.2010-2032.
35. Prentice A. Vitamin D deficiency: a global perspective. Nutr Rev 2008; 66(10 Suppl 2):S153-64. doi: 10.1111/j.1753-4887.2008.00100.x.
36. Sohl E, Heymans M W, de Jongh R T, den Heijer M, Visser M, Merlijn T, Lips P, van Schoor N M. Prediction of vitamin D deficiency by simple patient characteristics. Am J Clin Nutr 2014; 99(5):1089-95. doi: 10.3945/ajcn.113.076430.
37. Tran B, Armstrong B K, McGeechan K, Ebeling P R, English D R, Kimlin M G, Lucas R, van der Pols J C, Venn A, Gebski V, et al. Predicting vitamin D deficiency in older Australian adults. Clinical endocrinology 2013; 79(5):631-40. doi: 10.1111/cen.12203.
38. Bjorn Jensen C, Thorne-Lyman A L, Vadgard Hansen L, Strom M, Odgaard Nielsen N, Cohen A, Olsen S F. Development and validation of a vitamin D status prediction model in Danish pregnant women: a study of the Danish National Birth Cohort. PloS one 2013; 8(1):e53059. doi: 10.1371/journal.pone.0053059.
39. Bertrand K A, Giovannucci E, Liu Y, Malspeis S, Eliassen A H, Wu K, Holmes M D, Laden F, Feskanich D. Determinants of plasma 25-hydroxyvitamin D and development of prediction models in three US cohorts. The British journal of nutrition 2012; 108(10):1889-96. doi: 10.1017/S0007114511007409.
40. Millen A E, Wactawski-Wende J, Pettinger M, Melamed M L, Tylaysky F A, Liu S, Robbins J, LaCroix A Z, LeBoff M S, Jackson R D. Predictors of serum 25-hydroxyvitamin D concentrations among postmenopausal women: the Women's Health Initiative Calcium plus Vitamin D clinical trial. Am J Clin Nutr 2010; 91(5):1324-35. doi: 10.3945/ajen.2009.28908.
41. Lips P, van Schoor N M, de Jongh R T. Diet, sun, and lifestyle as determinants of vitamin D status. Annals of the New York Academy of Sciences 2014. doi: 10.1111/nyas.12443.

1. A method for establishing a process for screening vitamin D (Vit-D) insufficiency in a population of interest, comprising
determining a Vit-D status of a cohort of subjects of the population by measuring serum 25(OH)Vit-D level, wherein serum 25(OH)Vit-D level≦50 nmol/L indicates Vit-D insufficiency, and serum 25(OH)Vit-D level>50 nmol/L indicates Vit-D sufficiency, and wherein Vit-D insufficiency status is designated a value of “1” and Vit-D sufficiency status is designated a value of “0”;
obtaining a set of factors including constitutive skin melanin pigmentation measurement (Vf) and facultative skin melanin pigmentation measurement (Vh) in an individual subject, and one selected from the group consisting of: an age, a season, a gender, a body weight (BW), a standing height (SH), a physical activity level (PAL), a daily dietary Vit-D intake (Dvd), a daily dietary calcium intake (Dca), or any combination thereof in the individual subject, or transformed formats of the factors, wherein Vf is measured using skin colourimetry on an instep area, an inner aspect or a sole of a foot, or a heel of the individual subject, Vh is measured using skin colourimetry on a dorsum of a hand, fingers, a thumb or a wrist of the individual subject, the age, the BW, the SH, the PAL, the Dvd or the Dca is determined from the individual subject, the seasons are differentially designated pre-set values, and the genders are differentially designated pre-set values, and
carrying out a logistic regression analysis by using a Vit-D status as a dependent variable, and the factors or the transformed formats of the factors as independent variables, thereby obtaining a function as shown below with regression coefficients for each of the independent variables:
$${log}_{e} ( \frac{Pred}{1 - Pred} ) = α + {\sum }_{1}^{k} {β}_{i} {x}_{i} ,$$
wherein α is a constant term,
βᵢ is a regression coefficient for an independent variable xᵢ,
xᵢ represents the individual independent variables,
k represents a total number of the independent variables,
Pred is a predicted probability used for determining a screening result of either Vit-D insufficiency or Vit-D sufficiency according to a pre-set cut-off threshold of Pred.

2. The method of claim 1, wherein Vf and/or Vh is measured using Individual Typology Angle (ITA) based on a skin colourimetry system, e.g. L*a*b* colour system.

3. The method of claim 1, wherein in season factors, summer is designated value “1” and winter is designated value “2”, and/or in gender factors, male is designated value “1” and female is designated value “2”.

4. The method of claim 1, wherein the population of interest is an Asian population.

5. The method of claim 1, wherein the population of interest is a Chinese population.

6. The method of claim 1, wherein the population of interest is adolescent population in Hong Kong, and the obtained function is:
Logₑ(Pred/(1−Pred))=0.072(Vh)−0.095(Vf)−0.09(season)−0.297(gender)−0.005(BW/SH²)−0.29(age)+8.055.

7. The method of claim 1, wherein the population of interest is female adolescent population in Hong Kong with daily dietary Vit-D intake≦400 IU/day, and the obtained function is:
Logₑ(Pred/(1−Pred))=0.131(Vh)−0.162(Vf)−0.293(season)−0.104(BW/SH²)−0.358(age)+12.997.

8. The method of claim 1, wherein the population of interest is adolescent population in Hong Kong, and the obtained function is:
Logₑ(Pred/(1−Pred))=0.057(Vh)−0.087(Vf)−0.22(season)−0.015(gender)+0.007(BW)−0.034(SH)−0.203(age)−0.6(PAL)+13.388.

9. The method of claim 1, wherein the pre-set cut-off threshold of Pred is about 0.61.

10. A method for screening vitamin D (Vit-D) insufficiency in a subject, comprising:
providing a function for screening vitamin D (Vit-D) insufficiency in a population that the subject is from according to the method of claim 1,
obtaining a set of factors in the subject as defined in the function,
introducing the set of factors into the function thereby obtaining a Pred, and
comparing the calculated Pred with a pre-set cut-off threshold of Pred, wherein the calculated Pred≧the pre-set cut-off threshold of Pred indicates Vit-D insufficiency, and the calculated Pred<the pre-set cut-off threshold of Pred indicates Vit-D sufficiency.

11. The method of claim 10, wherein the providing a function for screening vitamin D (Vit-D) insufficiency includes establishing a function for screening vitamin D (Vit-D) insufficiency.

12. A device for screening vitamin D (Vit-D) insufficiency in a subject, comprising:
a measuring module configured to measure and record constitutive skin melanin pigmentation measurement (Vf) and facultative skin melanin pigmentation measurement (Vh) in the subject based on skin colourimetry, wherein Vf is measured on the instep area, the inner aspect or the sole of the foot, or the heel of the subject, and Vh is measured on the dorsum of the hand, the fingers, the thumb or the wrist of the subject,
an inputting module configured to record one or more or all of age, season, gender, body weight (BW), standing height (SH), physical activity level (PAL), daily dietary Vit-D intake (Dvd) and daily dietary calcium intake (Dca) in the subject, or transformed formats of the factors, wherein, age, BW, SH, PAL, Dvd or Dca is determined from the subject, seasons are differentially designated pre-set values, and male and female are differentially designated pre-set values, and
an processing module configured to run a function for screening vitamin D (Vit-D) insufficiency in a population that the subject is from according to the method of claim 1 and calculate a Pred.

13. The device of claim 12, further comprising a comparing module configured to compare the calculated Pred with a pre-set cut-off threshold of Pred, wherein the calculated Pred≧the pre-set cut-off threshold of Pred indicates Vit-D insufficiency, and the calculated Pred<the pre-set cut-off threshold of Pred indicates Vit-D sufficiency.

14. The device of claim 12, wherein the measuring module works based on Individual Typology Angle (ITA) measure, e.g. L*a*b* colour system.

15. The device of claim 12, wherein all the modules are incorporated into a skin colourimetry system, e.g. a skin colourimeter.

16. A computer product comprising a computer readable medium storing a plurality of instructions for carrying out the method of claim 1.

17. A computer product comprising a computer readable medium storing a plurality of instructions for carrying out the method of claim 10.
